(19) United States
(12) Patent Application Publication
(10) Pub. No.: US 2018/0355152 A1
(43) Pub. Date: Dec. 13, 2018

(54) PROCESS FOR MANUFACTURING A TIRE CONTAINING MICROCAPSULES, AND SAID TIRE

(71) Applicants: COMPAGNIE GENERALE DES ETABLISSEMENTS MICHELIN, CLERMONT-FERRAND (FR); MICHELIN RECHERCHE ET TECHNIQUE S.A., Granges-Paccot (CH)

(72) Inventors: JOSE-CARLOS ARAUJO DA SILVA, Clermont-Ferrand (FR); GARRY VEGI, Clermont-Ferrand (FR)

(21) Appl. No.: 16/060,696

(22) PCT Filed: Dec. 9, 2016
(86) PCT No.: PCT/EP2016/080356

§ 371 Date: Jun. 8, 2018

(30) Foreign Application Priority Data
Dec. 10, 2015 (FR) 1562104

(51) Int. Cl. C08K 9/10; B60C 1/00

(52) U.S. Cl. CPC C08K 9/10; B60C 1/0008; B60C 1/0016

(57) ABSTRACT

A process for the manufacture of a tyre, one of the parts of the tyre being based on an elastomeric composition comprising an elastomeric matrix and microcapsules, the elastomeric matrix comprising at least 50 phr of a thermoplastic elastomer, and the microcapsules consisting of a polymeric wall coating one or more active products, comprises a stage of addition of the microcapsules to the elastomeric matrix and then of mixing at a mixing temperature T_{mixing} at which the microcapsules retain their physical and chemical integrity, it being understood that the microcapsules also retain their physical and chemical integrity at the end of the process for the manufacture of the tyre. The boiling or decomposition point of the active product(s) of the microcapsules are greater by at least 30° C. than the glass transition temperature or, if appropriate, greater by at least 30° C. than the melting point of the thermoplastic block(s) of the thermoplastic elastomer in one such tire made by the process.

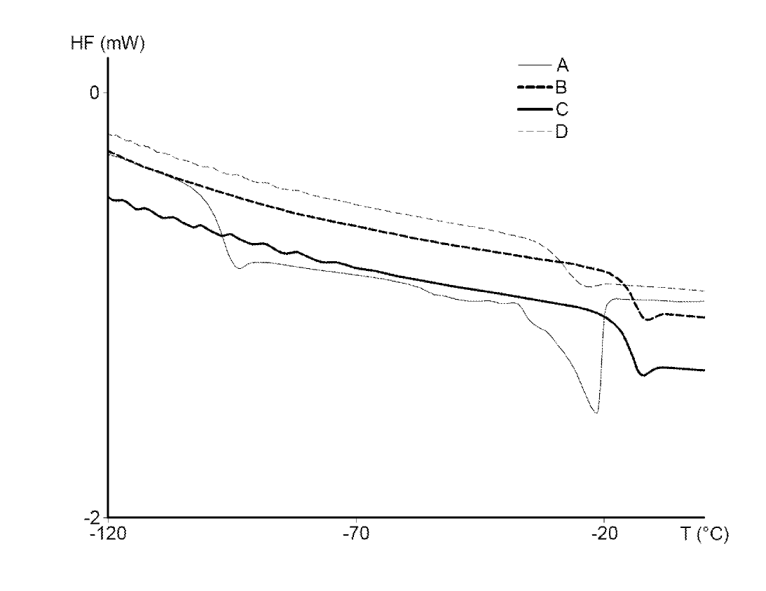

The present invention relates to a process for the manufacture of a tyre containing microcapsules which contain one or more active products.

The present invention also relates to a tyre which can be obtained from this process.

An ongoing objective of tyre manufacturers is to improve the properties of tyres (stiffness, grip, and the like), if possible, while retaining good processability of the tyres.

From this perspective, it may be desirable to develop tyres with controlled release of an active product under mechanical stress.

This active product can in particular be a protective agent, such as an antioxidant for protecting the inside of the tyre, and in particular the reinforcements for strengthening the crown of these tyres, also known as “belts”, from oxidation by atmospheric oxygen.

It can also be a plasticizing oil or a plasticizing resin for improving the dynamic properties of the tyre on its external surface.

Consequently, one of the solutions envisaged for obtaining the controlled release of an active product is the incorporation of microcapsules containing this product in the elastomeric composition.

However, the use of mixtures containing microcapsules which break and release their active product under mechanical stress could not be envisaged to date because the level of shearing undergone by the microcapsules during the compounding stages during the preparation of the tyre composition proves to be greater than the levels of shearing undergone by the microcapsules when the mixture is stressed in tyre use.

Thus, the direct consequence is the rupture of the microcapsules during the preparation of the tyre and not during its use, and thus the immediate release of all the active product into the mixture. The active product is then no longer available during the lifetime of the tyre. The advantage of a controlled release is thus lost.

The resistance of the microcapsules can be improved by reducing their diameter. However, when very small capsules are used, they no longer break when the mixture is stressed in tyre use.

The challenge is thus to minimize the shear stresses undergone by the mixture during the compounding stages, in order to retain the integrity of the microcapsules in the mixture, while retaining the possibility of bursting them when the mixture is stressed under tyre use. Furthermore, it is preferable not to modify the item of industrial equipment and thus to adapt the elastomeric mixture in order to reduce the shearing during the preparation of the compositions.

It has now been discovered, surprisingly, that this result could be obtained with a specific composition comprising an elastomeric matrix predominantly comprising at least one thermoplastic elastomer, and microcapsules containing the active product, and a specific process for the preparation of this composition.

Consequently, a subject-matter of the invention is a process for the manufacture of a tyre, at least one of the parts of the tyre being based on an elastomeric composition comprising an elastomeric matrix and microcapsules, the elastomeric matrix comprising at least 50 phr of at least one thermoplastic elastomer which comprises at least one elastomer block and at least one thermoplastic block, and the microcapsules consisting of a polymeric wall coating one or more active products, said process comprising a stage of addition of the microcapsules to the elastomeric matrix and then of mixing at a mixing temperature T_{mixing} at which the microcapsules retain their physical and chemical integrity, it being understood that the microcapsules also retain their physical and chemical integrity at the end of the process for the manufacture of the tyre.

This process makes it possible to manufacture a tyre comprising microcapsules which are physically and chemically intact at the end of the manufacturing process but which can be broken during mechanical stressing.

Consequently, this process makes it possible to manufacture a tyre having controlled release of an active product during its use. It is thus possible, for example, to lengthen its lifetime (case where the active product is a protective agent, such as an antioxidant) or to improve its dynamic properties (case where the active product is a plasticizing oil or a plasticizing resin).

Thus, another subject-matter of the invention is a tyre with at least one of the parts of the tyre being based on an elastomeric composition comprising an elastomeric matrix and microcapsules, the elastomeric matrix comprising at least 50 phr of at least one thermoplastic elastomer which comprises at least one elastomer block and at least one thermoplastic block, and the microcapsules consisting of a crosslinked polymeric wall coating one or more active products, the boiling or decomposition point of the active product(s) of the microcapsules being greater by at least 30° C. than the glass transition temperature or, if appropriate, greater by at least 30° C. than the melting point of the thermoplastic block(s) of the thermoplastic elastomer.

The invention and its advantages will be easily understood in the light of the description, of the exemplary embodiments which follow and of the single FIGURE, which represents a DSC thermogram showing the variation in the heat flow (HF) as a function of the temperature of different elastomeric compositions.

In the present description, unless expressly indicated otherwise, all the percentages (%) given are % by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The expression one of the parts of the tyre being “based on” an elastomeric composition should be understood as meaning that the part of the tyre concerned comprises a mixture and/or the reaction product of the different constituents used in the elastomeric composition, some of these base constituents being capable of reacting together or intended to react together, at least in part, during the different phases of manufacture of the part concerned, in particular during its crosslinking and/or its vulcanization.

“Elastomeric matrix” is understood to mean, within the meaning of the present invention, all of the elastomers (or rubbers) of the elastomeric composition, whether thermoplastic or non-thermoplastic. Thus, the elastomeric matrix can in particular consist of a single elastomer but also of a blend of two or more elastomers.

In the present patent application, “part per hundred of elastomer” or “phr” is understood to mean the part by weight of a constituent per 100 parts by weight of the elastomer(s) of the composition under consideration, that is to say of the total weight of the elastomer(s), whether thermoplastic or non-thermoplastic, present in the composition under consideration. Thus, a constituent at 60 phr will mean, for example, 60 g of this constituent per 100 g of elastomer of the composition under consideration.

“Microcapsule” is understood to mean a reservoir particle consisting of a core of gaseous, liquid or solid active product(s) surrounded by a continuous solid membrane (or wall) of coating material.

The microcapsules of the present invention generally have a diameter of between 1 and 100 μm.

“Active product” is understood to mean, within the meaning of the present invention, a product other than air, capable of preserving or of modifying the properties of the constituent mixtures or of a portion of the constituent mixtures of the tyre, or else of acting as indicator of use of the tyre or of a portion of the tyre containing it

Thermoplastic elastomer (TPE) is understood to mean, in a known way, a polymer with a structure intermediate between a thermoplastic polymer and an elastomer.

A thermoplastic elastomer consists of one or more rigid “thermoplastic” sequences connected to one or more flexible “elastomer” sequences. The rigid and flexible segments can be positioned linearly, in a star or branched configuration.

Typically, each of these segments or blocks contains a minimum of more than 5, generally of more than 10, base units.

“The microcapsules retain their physical or chemical integrity” is understood to mean that the microcapsules have not been subjected to a detrimental change in their form, in their composition or in their size.

Thus, as seen above, the manufacturing process according to the invention comprises a stage of addition of the microcapsules to the elastomeric matrix.

The constituent thermoplastic elastomer(s) of the elastomeric matrix which can be used in the process according to the invention generally have a number-average molecular weight (denoted Mn) ranging from 30 000 to 500 000 g/mol, preferably ranging from 40 000 to 400 000 g/mol.

The number-average molecular weight (Mn) of a thermoplastic elastomer is determined in a known way by size exclusion chromatography (SEC). The sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel (HMW7, HMW6E and two HT6E) trade names, is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

The polydispersity index (PI=Mw/Mn with Mw the weight-average molecular weight) of the constituent thermoplastic elastomer(s) of the elastomeric matrix which can be used in the process according to the invention is preferably less than 3; more preferably, the polydispersity index is less than 2 and more preferably still less than 1.5.

Preferably, the thermoplastic elastomer(s) of the elastomeric latex are chosen from essentially unsaturated thermoplastic elastomers.

“Essentially unsaturated” is generally understood to mean a thermoplastic elastomer, the elastomer blocks of which result at least in part from conjugated diene monomers, having a content of units of diene origin (conjugated dienes) which is greater than 15% (mol %). In the category of “essentially unsaturated” thermoplastic elastomers, “highly unsaturated” thermoplastic elastomer is understood in particular to mean a thermoplastic elastomer, the elastomer blocks of which have a content of units of diene origin (conjugated dienes) which is greater than 50%.

Very particularly preferably, the thermoplastic elastomer(s) of the elastomeric matrix are chosen from copolymers of styrene and of isoprene and/or of butadiene, and in particular the thermoplastic elastomer of the elastomeric matrix is a styrene/isoprene/styrene (SIS), styrene/butadiene/styrene (SBS) or styrene/butadiene-isoprene/styrene (SBIS) triblock copolymer.

The thermoplastic elastomer(s) of the elastomeric matrix have a content of at least 50 phr, that is to say that it represents at least 50% by weight of the total weight of the elastomeric matrix.

Preferably, in the present invention, the content of thermoplastic elastomers of the elastomeric matrix varies from 70 to 100 phr, preferably varies from 90 to 100 phr, in the elastomeric composition which can be used according to the invention.

Particularly preferably, in the present invention, the thermoplastic elastomer(s) of the elastomeric matrix are the only elastomers of the elastomeric composition which can be used according to the invention.

Nevertheless, the elastomeric composition which can be used in the process according to the invention can comprise other elastomers.

Mention may in particular be made, as other elastomers present in the elastomeric matrix in addition to the thermoplastic elastomers, of diene elastomers.

“Diene” elastomer or rubber should be understood as meaning, in a known manner, one or more elastomers resulting at least in part (i.e.; a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is understood generally to mean a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood in particular to mean a diene elastomer having a content of units of diene origin (conjugated dienes) which is greater than 50%.

Thus it is that diene elastomers, such as certain copolymers of dienes and of α-olefins of EPDM type, can be described as “essentially saturated” diene elastomers (low or very low content, always less than 15%, of units of diene origin).

Given these definitions, diene elastomer, whatever the above category, capable of being used in the elastomeric latex which can be used according to the invention is understood more particularly to mean:

(a) any homopolymer obtained by polymerization of a conjugated diene monomer having from 4 to 12 carbon atoms;

(b) any copolymer obtained by copolymerization of one or more conjugated dienes with one another or with one or more vinylaromatic compounds having from 8 to 20 carbon atoms;

(c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The abovementioned diene copolymers (category (b)) can contain between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent.

The following are suitable: polybutadienes and in particular those having a content (mol %) of 1,2-units of between 4% and 80% or those having a content (mol %) of cis-1,4-units of greater than 80%, polyisoprenes, butadiene/styrene copolymers and in particular those having a styrene content of between 5% and 50% by weight and more particularly between 20% and 40%, a content (mol %) of 1,2-bonds of the butadiene part of between 4% and 65% and a content (mol %) of trans-1,4-bonds of between 20% and 80%, butadiene/isoprene copolymers and in particular those having an isoprene content of between 5% and 90% by weight and a glass transition temperature (Tg, measured according to ASTM D3418) of −40° C. to −80° C., or isoprene/styrene copolymers and in particular those having a styrene content of between 5% and 50% by weight and a Tg of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2-units of the butadiene part of between 4% and 85%, a content (mol %) of trans-1,4-units of the butadiene part of between 6% and 80%, a content (mol %) of 1,2- plus 3,4-units of the isoprene part of between 5% and 70% and a content (mol %) of trans-1,4-units of the isoprene part of between 10% and 50%, and more generally any butadiene/styrene/isoprene copolymer having a Tg of between −20° C. and −70° C., are suitable in particular.

Mention may also be made, as other elastomers present in the elastomeric matrix in addition to the thermoplastic elastomer(s), of isoprene elastomers.

“Isoprene elastomer” is understood to mean, in a known way, an isoprene homopolymer or copolymer, in other words a diene elastomer selected from the group consisting of natural rubber (NR), synthetic polyisoprenes (IRs), the various isoprene copolymers and the mixtures of these elastomers. Mention will in particular be made, among the isoprene copolymers, of isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, more preferably still of greater than 98%.

As explained above, the microcapsules which can be used in the process according to the invention consist of a polymeric wall coating one or more active products.

Preferably, the polymeric wall of the microcapsules is crosslinked.

The polymeric wall of the microcapsules generally consists of one or more polymers chosen from thermosetting resins and thermoplastic elastomers; preferably, the polymeric wall of the microcapsules consists of one or more polymers chosen from thermosetting resins.

In a first embodiment of the invention, the polymeric wall of the microcapsules consists of one or more polymers chosen from thermosetting resins.

Thus, preferably, in this first embodiment, the thermosetting resins are chosen from polyepoxide resins, melamine/formaldehyde resins, phenol/formaldehyde resins, urea/formaldehyde resins, polyurethane resins, unsaturated polyester resins, vinyl ester resins, polyimide resins, diallyl phthalate resins, allyl diglycol carbonate resins and polyorganosiloxane resins; more preferably, the polymeric wall of the microcapsules consists of a melamine/formaldehyde, phenol/formaldehyde or urea/formaldehyde resin and more preferably still the polymeric wall of the microcapsules consists of a phenol/formaldehyde resin.

In a second embodiment of the invention, the polymeric wall of the microcapsules consists of one or more polymers chosen from thermoplastic elastomers.

Thus, preferably, in this second embodiment, the thermoplastic elastomers are chosen from styrene block copolymers (TPSs), polyurethanes (TPUs), vulcanized thermoplastic elastomers (VTPs), polyolefins (TPOs), polyamides (TPAs), polyether-block-amides (PEBAs) and copolyester-ethers (TPCs).

The active product(s) are advantageously chosen from protective agents, plasticizing oils, plasticizing resins, fragrances, colourants, diene elastomers, thermoplastic elastomers other than that of the elastomeric matrix and possibly of the elastomeric wall, and the mixtures of these products, and the active product(s) are preferably chosen from protective agents, plasticizing oils and plasticizing resins.

Suitable in particular as plasticizing oils and plasticizing resins are those described subsequently in the description regarding the plasticizing oils and the plasticizing resins optionally present in the elastomeric composition.

Protective agent(s) is understood to mean, in a known way, antioxidants, antiozonants, light stabilizers, UV absorbers and their mixtures.

Mention may be made, among antioxidants, of hindered phenol derivatives, p-phenylenediamines, quinoline, phosphites, hydroxylamine, thioethers and their combinations or mixtures.

Suitable in particular as antioxidants are pentaerythritol tetrakis(3-(3,5-di(tert-butyl)-4-hydroxyphenyl)propionate) (Irganox 1010), octadecyl 3-(3,5-di(tert-butyl)-4-hydroxyphenyl)propionate (Irganox 1076), quinoline derivatives (“TMQ”), tris(2,4-di(tert-butyl)phenyl) phosphite (Irgafos 168), 2-methyl-4,6-bis(octylsulfanylmethyl)phenol (Irganox 1520) and 2,6-di(tert-butyl)-4-(4,6-bis(octylthio)-1,3,5-triazin-2-ylamino)phenol (Irganox 565).

Suitable in particular as both antioxidants and antiozonants are N-isopropyl-N′-phenyl-p-phenylenediamine (“I-PPD”) or N-(1,3-dimethylbutyl)-N′-phenyl-p-phenylenediamine (“6-PPD”) and 2,4,6-tris(N-(1,4-dimethylpentyl)-p-phenylenediamino)-1,3,5-triazine (Durazone 37).

Suitable in particular as antiozonants are antiozone waxes, such as antiozone wax C32 ST.

Suitable in particular as light stabilizers are butanedioic acid, dimethyl ester, polymer with 4-hydroxy-2,2,6,6-tetramethyl-1-piperidineethanol (Tinuvin 622) and propanedioic acid, [[3,5-bis(1,1-dimethylethyl)-4-hydroxyphenyl]methyl]butyl-, bis(1,2,2,6,6-pentamethyl-4-piperidinyl) ester (Tinuvin 144).

Suitable in particular as UV stabilizers are phenol, 2-(2H-benzotriazol-2-yl)-4,6-bis(1-methyl-1-phenylethyl)-, (Tinuvin 234) and 2-(2H-benzotriazol-2-yl)-6-dodecyl-4-methylphenol (Tinuvin 571).

Preferably, the active product(s) are not blowing agents.

An elastomeric composition comprising an elastomeric matrix and microcapsules as defined above is sufficient to implement the process according to the invention.

However, the elastomeric composition which can be used in the process according to the invention can comprise other constituents.

Thus, the elastomeric composition which can be used in the process according to the invention can additionally comprise one or more fillers.

The term “filler” according to the invention groups together reinforcing fillers, semi-reinforcing fillers and inert fillers.

Reinforcing fillers is understood to mean, within the meaning of the present invention, any type of filler known for its ability to reinforce an elastomeric composition which can be used for the manufacture of tyres, for example an organic filler, such as carbon black, or alternatively a reinforcing inorganic filler.

Thus, in the present invention, the elastomeric composition can comprise from 1 to 160 phr of carbon black.

All carbon blacks, in particular blacks of the HAF, ISAF or SAF type, conventionally used in tyres (“tyre-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example N660, N683 or N772), indeed even N990.

Of course, it is possible to use just one carbon black or a blend of several carbon blacks of different ASTM grades.

In the elastomeric composition which can be used in the process according to the invention, the carbon black can constitute the only filler of the composition.

The elastomeric composition which can be used in the process according to the invention can also comprise, apart from the carbon black, one or more additional fillers.

This or these additional filler(s) can be chosen from reinforcing fillers other than carbon black, semi-reinforcing fillers and inert fillers.

Thus, the elastomeric composition in the process according to the invention can also comprise one or more reinforcing inorganic fillers.

“Reinforcing inorganic filler” should be understood, in the present patent application, by definition, as meaning any inorganic or mineral filler, whatever its colour and its origin (natural or synthetic), also referred to as “white filler”, “clear filler”, indeed even “non-black filler”, in contrast to carbon black, capable of reinforcing, by itself alone, without means other than an intermediate coupling agent, an elastomeric composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of microbeads, of granules, of beads or any other appropriate densified form. Of course, reinforcing inorganic filler is also understood to mean mixtures of different reinforcing inorganic fillers, in particular of highly dispersable siliceous and/or aluminous fillers, such as described below.

Mineral fillers of the siliceous type, especially silica (SiO₂), or of the aluminous type, especially alumina (Al₇O₃), are suitable in particular as reinforcing inorganic fillers. The silica used can be any reinforcing silica known to a person skilled in the art, in particular any precipitated or fumed silica exhibiting a BET specific surface and also a CTAB specific surface both of less than 450 m²/g, preferably from 30 to 400 m²/g.

Mention will be made, as highly dispersible precipitated silicas (known as “HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

Finally, a person skilled in the art will understand that, as filler equivalent to the reinforcing inorganic filler described in the present section, use may be made of a reinforcing filler of another nature, in particular organic nature, provided that this reinforcing filler is covered with an inorganic layer, such as silica, or else comprises functional sites, in particular hydroxyl sites, at its surface.

The presence, in an elastomeric composition, of a reinforcing inorganic filler or of a reinforcing filler of another nature covered with an inorganic layer or comprising functional sites at its surface generally requires the use of a coupling agent in order to establish the bond between the filler and the elastomer.

It is recalled here that “coupling agent” is understood to mean, in a known way, an agent capable of establishing a sufficient bond, of physical and/or chemical nature, between the inorganic filler (or filler of another nature, as seen above) and the elastomer.

Such coupling agents, in particular silica/elastomer coupling agents, have been described in a very large number of documents, the most well-known being bifunctional organosilanes bearing alkoxy functional groups (that is to say, by definition, “alkoxysilanes”) and functional groups capable of reacting with the elastomer, such as, for example, polysulfide functional groups.

As seen above, the additional filler(s) optionally present in the elastomeric composition which can be used in the process according to the invention can be chosen from semi-reinforcing fillers.

Semi-reinforcing fillers are not capable, by themselves alone, of reinforcing an elastomeric composition intended for the manufacture of tyres; in other words, they are not suitable for replacing, in its reinforcement role, a conventional tyre-grade carbon black; however, they make possible an increase in the tensile modulus of an elastomeric composition in which they are incorporated, which is why they are referred to as “semi-reinforcing”.

Mention may in particular be made, as semi-reinforcing filler optionally present within the meaning of the present invention, of graphite.

Graphite is understood to mean, generally, an assembly of non-compact hexagonal lamellae of carbon atoms: graphenes. Graphite, a hexagonal crystalline system, exhibits a stack of ABAB type where the B plane is translated relative to the A plane; it belongs to the crystalline group: P63/mmc space group.

Graphite cannot be regarded as a reinforcing filler, in contrast to carbon black or to silica. It simply makes possible an increase in the tensile modulus of an elastomeric composition in which it is incorporated but does not make it possible to reinforce this composition.

Given these definitions, graphite capable of being used according to the invention is understood more particularly to mean:

(a) any natural graphite, associated with rocks affected by metamorphism, after separation of the impurities accompanying the graphite veins and after milling;

(b) any thermally expandable natural graphite, i.e. in which a chemical compound in the liquid state, for example an acid, is intercalated between its graphene planes;

(c) any expanded natural graphite, the latter being produced in two steps: intercalation of a chemical compound in the liquid state, for example an acid, between the graphene planes of a natural graphite by chemical treatment, and high-temperature expansion;

(d) any synthetic graphite obtained by graphitization of petroleum coke.

The elastomeric composition which can be used in the process according to the invention can contain just one graphite or a mixture of several graphites; thus, it is possible to have a blend of natural graphite and/or of expanded graphite and/or of synthetic graphite.

The graphite as defined above can be provided morphologically in a lamellar or non-lamellar form.

Preferably, the graphite which can be used according to the invention is provided in lamellar form.

As seen above, the additional filler(s) can be chosen from inert fillers.

The inert filler(s) which can be used according to the invention can be chosen from chalk, clay, bentonite, talc, kaolin, glass microbeads, glass flakes and a mixture of these compounds.

In the present invention, the carbon black can advantageously constitute the only reinforcing filler or the predominant reinforcing filler.

More particularly preferably, the carbon black can advantageously constitute the only filler of the elastomeric composition.

The elastomeric composition which can be used in the process according to the invention can additionally comprise a plasticizing agent, in addition to the possible plasticizing agent (oil and/or resin) used as active product in the microcapsules.

In a way known to a person skilled in the art, a “plasticizing agent” is by definition a compound which is liquid or solid at ambient temperature (23° C.) and atmospheric pressure (1.013×10⁵ Pa) and which is compatible, that is to say miscible at the content used, with the elastomeric composition for which it is intended, so as to act as a true diluting agent.

Preferably, in the present invention, the plasticizing agent is chosen from plasticizing oils and plasticizing resins.

By definition, a plasticizing oil (also known as liquid plasticizer) is liquid at ambient temperature and atmospheric pressure.

This or these plasticizing oil(s) generally have a low glass transition temperature of less than −20° C. (Tg, measured according to ASTM D3418), preferably of less than −40° C.

The glass transition temperatures are measured in a known way by DSC (Differential Scanning calorimetry) according to Standard ASTM D3418.

Use may be made, as plasticizing oil which can be used in the process according to the invention, of all “extending” oils, whether they are of aromatic or non-aromatic nature, known for their plasticizing properties with regard to the elastomers used in the present invention.

Plasticizing oils selected from the group consisting of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils, mineral oils, vegetable oils, ether plasticizers, ester plasticizers, phosphate plasticizers, sulfonate plasticizers and the mixtures of these compounds are particularly suitable.

Liquid polymers resulting from the polymerization of olefins or dienes, such as, for example, those selected from the group constituted by polybutenes, polydienes, in particular polybutadienes, polyisoprenes, copolymers of butadiene and isoprene, copolymers of butadiene or isoprene and styrene, and the mixtures of these liquid polymers are also suitable. The number-average molar mass of such liquid polymers is preferably within a range extending from 500 g/mol to 50 000 g/mol, more preferably from 1000 g/mol to 10 000 g/mol. Mention may in particular be made, by way of example, of the Ricon products from Sartomer.

Functionalized or non-functionalized polyisobutylene oils having a molecular weight of between 200 g/mol and 40 000 g/mol are also suitable.

According to another preferred embodiment of the invention, the plasticizing oil(s) are vegetable oils (such as linseed oil, safflower oil, soybean oil, maize oil, cottonseed oil, rapeseed oil, castor oil, tung oil, pine oil, sunflower oil, palm oil, olive oil, coconut oil, peanut oil, grapeseed oil and the mixtures of these oils, in particular a sunflower oil).

According to another specific embodiment of the invention, the plasticizing oil(s) are an ether, such as, for example, polyethylene glycols or polypropylene glycols.

Plasticizing oils selected from the group consisting of ester plasticizers, phosphate plasticizers, sulfonate plasticizers and the mixtures of these compounds are also suitable.

As a reminder, the plasticizing agent can also be chosen from plasticizing resins.

In contrast with plasticizing oils, plasticizing resin is understood to mean a compound which is solid at ambient temperature (23° C.) and at atmospheric pressure (1.013×10⁵ Pa).

This or these plasticizing resin(s) generally have a glass transition temperature of greater than 20° C. (Tg, measured according to ASTM D3418), preferably of greater than 30° C.

Preferably, the plasticizing resins which can be used according to the invention are hydrocarbon plasticizing resins.

Hydrocarbon resins are polymers which are well known to a person skilled in the art, which are thus miscible by nature in elastomer compositions, when they are additionally described as “plasticizing”.

These hydrocarbon plasticizing resins generally exhibit a glass transition temperature of greater than 20° C. and a softening point of less than 170° C.

The softening points are measured according to Standard ASTM E-28.

These resins have been widely described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”).

They can be aliphatic, naphthenic or aromatic or else of the aliphatic/naphthenic/aromatic type, that is to say based on aliphatic and/or naphthenic and/or aromatic monomers. They can be natural or synthetic and may or may not be based on petroleum (if such is the case, they are also known under the name of petroleum resins). They are preferably exclusively hydrocarbon, that is to say that they comprise only carbon and hydrogen atoms.

According to a particularly preferred embodiment, the plasticizing hydrocarbon resin is selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins, which can be used alone or in combination with a liquid plasticizer, for example an MES or TDAE oil (See, for example, Applications WO2005/087859, WO2006/061064 or WO2007/017060).

The preferred resins above are well known to a person skilled in the art and are commercially available. Mention may be made, among the commercially available plasticizing resins based on terpene resins, for example, of a poly(a-pinene) resin sold by Hercules Inc. of Wilmington, Del., under the name Resin R2495. Resin R2495 has a molecular weight of approximately 932, a softening point of approximately 135° C. and a glass transition point of approximately 91° C. Another conforming resin is Dercolyte L120, sold by DRT in France. Dercolyte L120 is a polyterpene/limonene resin having a number-average molar mass of approximately 625 g/mol, a weight-average molar mass of approximately 1010 g/mol, a polydispersity index PI of approximately 1.6, a softening point of approximately 119° C. and a glass transition point of approximately 72° C. Sylvares TR 7125 and/or Sylvares TR 5147 are other conforming plasticizing resins sold by Arizona Chemical Company of Jacksonville, Fla. Sylvares 7125 is a polylimonene resin having a molecular weight of approximately 1090 g/mol, a softening point of approximately 125° C. and a glass transition temperature of approximately 73° C., while Sylvares TR 5147 has a molecular weight of approximately 945 g/mol, a softening point of approximately 120° C. and a glass transition temperature of approximately 71° C.

For example, mention may be made, among C₅ fraction/vinylaromatic copolymer resins, in particular C₅ fraction/styrene or C₅ fraction/C₉ fraction copolymer resins, of the resins sold by by Neville Chemical Company under the names Super Nevtac 78, Super Nevtac 85 and Super Nevtac 99, by Goodyear Chemicals under the name Wingtack Extra, by Kolon under the names Hikorez T1095 and Hikorez T1100 or by Exxon under the names Escorez 2101 and ECR 373.

For example, mention may be made, among limonene/styrene copolymer resins, of the resins sold by DRT under the name Dercolyte TS 105 and by Arizona Chemical Company under the names ZT115LT and ZT5100.

Mention may also be made, as examples of other preferred resins, of phenol-modified α-methylstyrene resins. It should be remembered that a number referred to as “hydroxyl number” (measured according to Standard ISO 4326 and expressed in mg KOH/g) is used in a known way in order to characterize these phenol-modified resins. α-Methylstyrene resins, in particular those which are phenol-modified, are well known to a person skilled in the art and are commercially available, for example sold by Arizona Chemical under the names Sylvares SA 100 (Mn=660 g/mol; PI=1.5; Tg=53° C.); Sylvares SA 120 (Mn=1030 g/mol; PI=1.9; Tg=64° C.); Sylvares 540 (Mn=620 g/mol; PI=1.3; Tg=36° C.; hydroxyl number=56 mg KOH/g); and Sylvares 600 (Mn=850 g/mol; PI=1.4; Tg=50° C.; hydroxyl number=31 mg KOH/g).

The content of plasticizing agent in the elastomeric composition which can be used in the process according to the invention, in addition to the possible plasticizing agent used as active product in the microcapsules, generally varies from 0 to less than 10 phr.

The elastomeric composition which can be used in the process according to the invention can also comprise all or a portion of the usual additives generally used in elastomeric compositions intended for the manufacture of tyres, such as, for example, protective agents, such as antiozonants or antioxidants, light stabilizers, UV absorbers, methylene acceptors (for example phenolic novolak resin) or methylene donors (for example HMT or H3M), a crosslinking system based either on sulfur, or on sulfur donors and/or on peroxide and/or on bismaleimides and/or vulcanizing resins, vulcanization accelerators or vulcanization activators.

Thus, as seen above, the manufacturing process according to the invention comprises a stage of addition of microcapsules to the elastomeric matrix and then of mixing at a mixing temperature T_{mixing} at which the microcapsules retain their physical and chemical integrity, it being understood that the microcapsules also retain their physical and chemical integrity at the end of the process for the manufacture of the tyre.

Particularly preferably in the present invention, the mixing temperature T_{mixing} is greater than the glass transition temperature or, if appropriate, greater than the melting point of the thermoplastic block(s) of the thermoplastic elastomer and less than the decomposition or boiling point of the active product(s) of the microcapsules.

Very particularly preferably in the present invention, the mixing temperature T_{mixing} is greater by at least 30° C. than the glass transition temperature or, if appropriate, greater by at least 30° C. than the melting point of the thermoplastic block(s) of the thermoplastic elastomer and less than the decomposition or boiling point of the active product(s) of the microcapsules.

It is known that the thermoplastic elastomers comprising at least one elastomer block and at least one thermoplastic block exhibit two glass transition temperature (Tg, measured according to ASTM D3418) peaks, the lowest temperature being relative to the elastomer part of the block copolymer and the highest temperature being relative to the thermoplastic part of the block copolymer. Thus, the elastomer blocks of the block copolymer are defined by a Tg which is less than ambient temperature (25° C.), while the thermoplastic blocks of the block copolymer have a Tg which is greater than 80° C.

The glass transition temperature (Tg) characteristic of the rigid thermoplastic block is well known to a person skilled in the art as it makes it possible in particular to choose the industrial processing (transformation) temperature. In the specific case of a semicrystalline polymer (or polymer block), a melting point may be observed which is then greater than the glass transition temperature. In this case, it is instead the melting point (M.p., measured according to ASTM D3418) which makes it possible to choose the processing temperature for the polymer (or polymer block) under consideration.

“Decomposition point” of a compound is understood to mean the temperature at which the compound decomposes chemically, that is to say some of the chemical bonds of the compound break to give less complex compounds.

Advantageously, when the polymeric wall of the microcapsules which can be used according to the invention consists of one or more polymers chosen from thermoplastic elastomers, the mixing temperature T_{mixing} is less than the glass transition temperature or, if appropriate, less than the melting point of the thermoplastic block(s) of the thermoplastic elastomers of the wall.

Thus, very particularly preferably, the mixing temperature T_{mixing} varies from 80° C. to 260° C., preferably varies from 90° C. to 200° C.

Preferably, in the present invention, the microcapsules are added to the elastomeric matrix in the form of a suspension in water, also known as “slurry”.

In this mixing stage, the different constituents of the composition of the elastomeric composition are present (elastomeric matrix, microcapsules and the optional additional constituents: filler, plasticizers, and the like), with the exception of the optional crosslinking system.

This compounding stage generally has a duration ranging from 1 to 15 min.

The process for the manufacture of the tyre generally comprises a second phase of mechanical working (“productive” phase) at a lower temperature than the temperature T_{mixing} but greater than the glass transition temperature or, if appropriate, greater than the melting point of the thermoplastic block(s) of the thermoplastic elastomer and less than the decomposition or boiling point of the active product(s) of the microcapsules. Typically, the temperature of the “productive” phase is less than 130° C., for example between 80° C. and 120° C., and, during this finishing phase, the optional crosslinking system can be incorporated.

The combined mixture is then mixed for a few minutes, for example between 2 and 15 min.

The crosslinking system proper is preferably based on sulfur and on a primary vulcanization accelerator, in particular on an accelerator of the sulfenamide type. Additional to this vulcanization system are optionally various known secondary vulcanization accelerators or vulcanization activators, such as zinc oxide, stearic acid, guanidine derivatives (in particular diphenylguanidine), and the like, incorporated during the first compounding phase and/or during the productive phase. The sulfur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of the thermoplastic elastomers which can be used according to the invention in the presence of sulfur, in particular accelerators of the thiazole type and their derivatives and accelerators of the thiuram and zinc dithiocarbamate types. These accelerators are more preferably selected from the group consisting of 2-mercaptobenzothiazyl disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBBS”), N-(tert-butyl)-2-benzothiazolesulfenimide (abbreviated to “TBSI”), zinc dibenzyldithiocarbamate (abbreviated to “ZBEC”) and the mixtures of these compounds.

Use is preferably made of a primary accelerator of the sulfenamide type.

The final composition thus obtained can subsequently be calendered, for example in the form of a sheet or of a plaque, in particular for laboratory characterization, or also extruded, in order to form one of the parts or all of the tyre.

Thus, preferably, in the process according to the invention, the at least one of the parts of the tyre is a tread or an airtight layer.

Thus, the process according to the invention makes it possible to manufacture a tyre.

Consequently, another subject-matter of the invention is a tyre with at least one of the parts of the tyre being based on an elastomeric composition comprising an elastomeric matrix and microcapsules, the elastomeric matrix comprising at least 50 phr of at least one thermoplastic elastomer which comprises at least one elastomer block and at least one thermoplastic block, and the microcapsules consisting of a crosslinked polymeric wall coating one or more active products, the boiling or decomposition point of the active product(s) of the microcapsules being greater by at least 30° C. than the glass transition temperature or, if appropriate, greater by at least 30° C. than the melting point of the thermoplastic block(s) of the thermoplastic elastomer.

As explained above, with the term “based on”, it should be understood that the part of the tyre concerned comprises a mixture and/or the reaction product of the different constituents used in the elastomeric composition, some of these base constituents being capable of reacting together or intended to react together, at least in part, during the different phases of manufacture of the part concerned, in particular during its crosslinking and/or its vulcanization.

However, it should be understood, within the meaning of the present invention, that the microcapsules of the pneumatic object are chemically and physically intact in the pneumatic object after its preparation, that is to say after the reaction of the different constituents of the elastomeric composition during its preparation.

The composition used in the tyre, which is a subject-matter of the invention, advantageously exhibits the characteristics of the elastomeric composition employed in the process, which is a subject-matter of the invention; in particular, it concerns the characteristics relating to the thermoplastic elastomers, to the optional other elastomers present in the elastomeric composition, to the microcapsules, to the optional fillers present in the elastomeric composition, to the optional plasticizing agents present in the elastomeric composition and to the optional additives present in the elastomeric composition.

The invention and its advantages will be more thoroughly understood in the light of the exemplary embodiments and of the single FIGURE which follow.

Measurement Methods

Protocol for Preparing Microcapsules

A solution containing 908 g of water and 200 g of a 20% solution of sodium salt of a poly(2-acrylamido-2-methylpropionic acid) (viscosity: 770 mPa·s) is prepared.

The combined constituents are mixed in a 4-litre cylindrical container having a disperser (45 ®Turrax N type). This mixture, which constitutes the continuous aqueous phase, is brought to pH 4.5 and is heated to 60° C.

800 g of high-oleic sunflower oil as active product (Captex 20539 Agripure 80) are dispersed in the aqueous phase. The dispersion thus obtained is stable and colourless. The combined mixture is subsequently stirred at a rotational speed of 7000 revolutions per minute.

A solution of 120 g of a partially methylated pre-condensate containing 1 mol of melamine and 5.25 mol of formaldehyde (pre-condensate containing approximately 2.3 CH₃O groups per molecule of melamine and giving a clear solution in water) in 132 g of water and brought to pH 4.5 is prepared.

The stable colourless dispersion obtained above is gradually added to this solution at 60° C. over 60 minutes.

After approximately 30 minutes, examination of a sample using a microscope makes it possible to observe that the formation of microcapsules has taken place, since the droplets of emulsion no longer coalesce on the microscope slide.

After a total of 65 minutes, the dispersion of microcapsules obtained is again subjected to stirring at 60° C. for 3.5 hours, this time with a propeller mixer rotating at 500 revolutions per minute. The dispersion is subsequently cooled, brought to pH 7.0 and sieved through a sieve with a mesh size of 40 μm. 0.7 g of solid residue is recovered on the sieve.

After 120 minutes (starting from the beginning of the addition of the pre-condensate), the capsules have already sufficiently hardened for a sample of the dispersion on a plate coated with silica gel not to give water/oil phase separation after drying.

The dispersion obtained is colourless and milky and, by examination using a microscope, the individual capsules have a size predominantly of between 12 and 15 μm in diameter. The solids content is 42.8%. Formaldehyde odours are noticed in the dispersion.

In order to be rid of the formaldehyde odour, a dispersion of microcapsules is prepared as described above and is brought to pH 7, 21.6 g of ethyleneurea and 25 g of water are added and the mixture is slowly stirred at ambient temperature for 24 hours. After this operation, the formaldehyde odour has disappeared.

Protocol for the Preparation of a Tyre According to the Invention

A matrix consisting of 100 phr of a thermoplastic elastomer is kneaded under hot conditions at a temperature greater than the glass transition temperature of the thermoplastic blocks but less than the boiling or decomposition point of the active product. The compounding temperature is 170° C. in the case of thermoplastic styrene elastomers.

The matrix is kneaded under hot conditions for 2 minutes and then the microcapsules, synthesized above, are introduced in the form of a slurry (microcapsules/water ratio by weight ranging from 50/50 to 80/10). The matrix and the slurry of microcapsules are kneaded under hot conditions for 1 to 2 minutes, more preferably one minute.

The mixture is subsequently shaped by means of a heated calender, of a platen press or of an extruder.

The tyre is subsequently assembled in the raw state and then cured.

Elastomeric Compositions Prepared According to the Process of the Invention

The elastomeric compositions are prepared from Table 1 below and the protocols above.

TABLE 1

| Constituents | Composition A | | Composition B | |
|---|---|---|---|---|
| SIS (Kraton D1161) | 100 | phr | — | |
| Vinyl-bond rich SIS | — | | 100 | phr |
| (Hybrar 5125) | | | | |
| Microcapsules⁽¹⁾ | 25 | phr | 25 | phr |

⁽¹⁾particle size average distribution D50 = 15 μm, wall made of melamine/formaldehyde resin, active product: sunflower oil

Performance Measurement

DSC measurements were carried out. The measurement conditions are as follows:
starting temperature: 23° C.
heating up to 200° C., cooling down to −150° C.
heating at 3 K/min up to 250° C. with data acquisition.

The results are collated in the single FIGURE:
the curve A represents the DSC measurement of the microcapsules alone,
the curve B represents the DSC measurement of a composition consisting solely of the polymer Hybrar 5125,
the curve C represents the DSC measurement of the composition B after the compounding,
the curve D represents the DSC measurement of the composition B after mechanical stressing.

This graph shows the properties of the elastomeric matrix are virtually unaffected by the presence of microcapsules and that the process according to the invention does not modify the properties of the mixture with microcapsules (comparative test curves B and C).

However, when the mixture with the microcapsules is mechanically stressed with a shock impactor (hammer), the graph (curve D) which is obtained shows an offset in Tg of the material, a sign that microcapsules have broken. In this instance, the offset in Tg is −17° C., which corresponds to the release of 14% by weight of oil, or also to 56% of microcapsules burst.

Similar results have been obtained with the same melamine/formaldehyde wall and microcapsule diameters of between 1 and 100 μm.

1.-15. (canceled)

16. A process for the manufacture of a tire, at least one part of the tire being based on an elastomeric composition comprising an elastomeric matrix and microcapsules, the elastomeric matrix comprising at least 50 phr of at least one thermoplastic elastomer which comprises at least one elastomer block and at least one thermoplastic block and the microcapsules consisting of a polymeric wall coating at least one active product, said process comprising the steps of:
adding the microcapsules to the elastomeric matrix; and then
mixing at a mixing temperature T_{mixing} at which the microcapsules retain their physical and chemical integrity,
wherein the microcapsules retain their physical and chemical integrity at the end of the process for the manufacture of the tire.

17. The process according to claim 16, wherein the at least one thermoplastic elastomer of the elastomeric matrix is selected from the group consisting of essentially unsaturated thermoplastic elastomers.

18. The process according to claim 17, wherein the at least one thermoplastic elastomer of the elastomeric matrix is selected from the group consisting of copolymers of styrene and isoprene, copolymers of styrene and butadiene, copolymers of styrene, butadiene and isoprene, and combinations thereof.

19. The process according to claim 18, wherein the at least one thermoplastic elastomer of the elastomeric matrix is selected from the group consisting of styrene/isoprene/styrene (SIS), styrene/butadiene/styrene (SBS) and styrene/butadiene-isoprene/styrene (SBIS) triblock copolymers.

20. The process according to claim 16, wherein the content of the at least one thermoplastic elastomer of the elastomeric matrix varies from 70 to 100 phr.

21. The process according to claim 20, wherein the content of the at least one thermoplastic elastomer of the elastomeric matrix varies from 90 to 100 phr.

22. The process according to claim 16, wherein the polymeric wall of the microcapsules is crosslinked.

23. The process according to claim 16, wherein the polymeric wall of the microcapsules consists of one or more polymers chosen from the group consisting of thermosetting resins and thermoplastic elastomers.

24. The process according to claim 23, wherein the polymeric wall of the microcapsules consists of at least one thermosetting resin.

25. The process according to claim 23, wherein the thermosetting resins are selected from the group consisting of polyepoxide resins, melamine/formaldehyde resins, phenol/formaldehyde resins, urea/formaldehyde resins, polyurethane resins, unsaturated polyester resins, vinyl ester resins, polyimide resins, diallyl phthalate resins, allyl diglycol carbonate resins and polyorganosiloxane resins.

26. The process according to claim 25, wherein the thermosetting resins are selected from the group consisting of melamine/formaldehyde, phenol/formaldehyde and urea/formaldehyde resins.

27. The process according to claim 26, wherein the polymeric wall of the microcapsules consists of a phenol/formaldehyde resin.

28. The process according to claim 23, wherein the thermoplastic elastomers of the polymeric wall are selected from the group consisting of styrene block copolymers (TPSs), polyurethanes (TPUs), vulcanized thermoplastic elastomers (VTPs), polyolefins (TPOs), polyamides (TPAs), polyether-block-amides (PEBAs) and copolyester-ethers (TPCs).

29. The process according to claim 16, wherein the at least one active product is selected from the group consisting of protective agents, plasticizing oils, plasticizing resins, fragrances, colorants, diene elastomers, thermoplastic elastomers, and mixtures thereof, and
wherein the thermoplastic elastomers of the at least one active product are different from the at least one thermoplastic elastomer of the elastomeric matrix and are different from the thermoplastic elastomers of the polymeric wall.

30. The process according to claim 29, wherein the at least one active product is selected from the group consisting of protective agents, plasticizing oils and plasticizing resins.

31. The process according to claim 16, wherein the mixing temperature T_{mixing} is greater than the glass transition temperature or, if appropriate, greater than the melting point of the at least one thermoplastic block of the at least one thermoplastic elastomer of the elastomeric matrix and less than the decomposition or boiling point of the at least one active product of the microcapsules.

32. The process according to claim 31, wherein the mixing temperature T_{mixing} is greater by at least 30° C. than the glass transition temperature or, if appropriate, greater by at least 30° C. than the melting point of the at least one thermoplastic block of the at least one thermoplastic elastomer of the elastomeric matrix and less than the decomposition or boiling point of the at least one active product of the microcapsules.

33. The process according to claim 16, wherein the polymeric wall of the microcapsules consists of one or more polymers selected from the group consisting of thermoplastic elastomers and the mixing temperature T_{mixing} is less than the glass transition temperature or, if appropriate, less than the melting point of an at least one thermoplastic block of the thermoplastic elastomers of the polymeric wall.

34. The process according to claim 16, wherein the mixing temperature T_{mixing} varies from 80° C. to 260° C.

35. The process according to claim 34, wherein the mixing temperature T_{mixing} varies from 90° C. to 200° C.

36. The process according to claim 16, wherein the microcapsules are added to the elastomeric matrix in the form of a suspension in water.

37. The process according to claim 16, wherein the at least one part of the tire is a tread or an airtight layer.

38. A tire having at least one of the part of which is based on an elastomeric composition comprising an elastomeric matrix and microcapsules, the elastomeric matrix comprising at least 50 phr of at least one thermoplastic elastomer which comprises at least one elastomer block and at least one thermoplastic block and the microcapsules consisting of a crosslinked polymeric wall coating at least one active product,
wherein the boiling or decomposition point of the at least one active product of the microcapsules is greater by at least 30° C. than the glass transition temperature or, if appropriate, greater by at least 30° C. than the melting point of the at least one thermoplastic block of the at least one thermoplastic elastomer of the elastomeric matrix.
